(19) United States
(12) Patent Application Publication
(10) Pub. No.: US 2016/0306095 A1
(43) Pub. Date: Oct. 20, 2016

(54) LIGHT GUIDE PLATE AND BACKLIGHT MODULE HAVING THE SAME

(71) Applicant: HON HAI PRECISION INDUSTRY CO., LTD., New Taipei (TW)

(72) Inventors: CHAU-JIN HU, Tu-Cheng (TW); FENG-YUEN DAI, Tu-Cheng (TW); PO-CHOU CHEN, Tu-Cheng (TW); HSIN-HUA CHANG, Tu-Cheng (TW)

(21) Appl. No.: 14/819,957

(22) Filed: Aug. 6, 2015

(30) Foreign Application Priority Data
Apr. 17, 2015 (TW) 104112490

(51) Int. Cl. F21V 8/00

(52) U.S. Cl. CPC G02B 6/0023; G02B 6/0025; G02B 6/0031

(57) ABSTRACT

A light guide plate is applied in a backlight module including at least one light source. The light guide plate includes a light guide body and a light collecting member. The light guide body includes a first light incident surface and a first light emitting surface. The light guide body is made of transparent glass. The light collecting member is attached to and covers a portion of the first light emitting surface and adjacent to the first light incident surface. The light collecting member is made of resin.

### FIELD

The subject matter herein generally relates to a light guide plate, and a backlight module using the light guide plate.

### BACKGROUND

Backlight modules are employed in display devices. A backlight module includes a light source and a light guide plate. In operation, the light source irradiates light to a front surface of the display device through the light guide plate. The light guide plate is usually made of resin material and formed by injection molding. A light guide plate usually has a thickness of more than 0.4 mm.

### BRIEF DESCRIPTION OF THE DRAWINGS

Implementations of the present technology will now be described, by way of example only, with reference to the attached figures.

FIG. 1 is a diagrammatic view of a first embodiment of a backlight module according to the present disclosure.

FIG. 2 is similar to FIG. 1, but showing the backlight module from another angle.

FIG. 3 is a diagrammatic view of a second embodiment of a backlight module.

FIG. 4 is a diagrammatic view of a third embodiment of a backlight module.

FIG. 5 is a diagrammatic view of a fourth embodiment of a backlight module.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

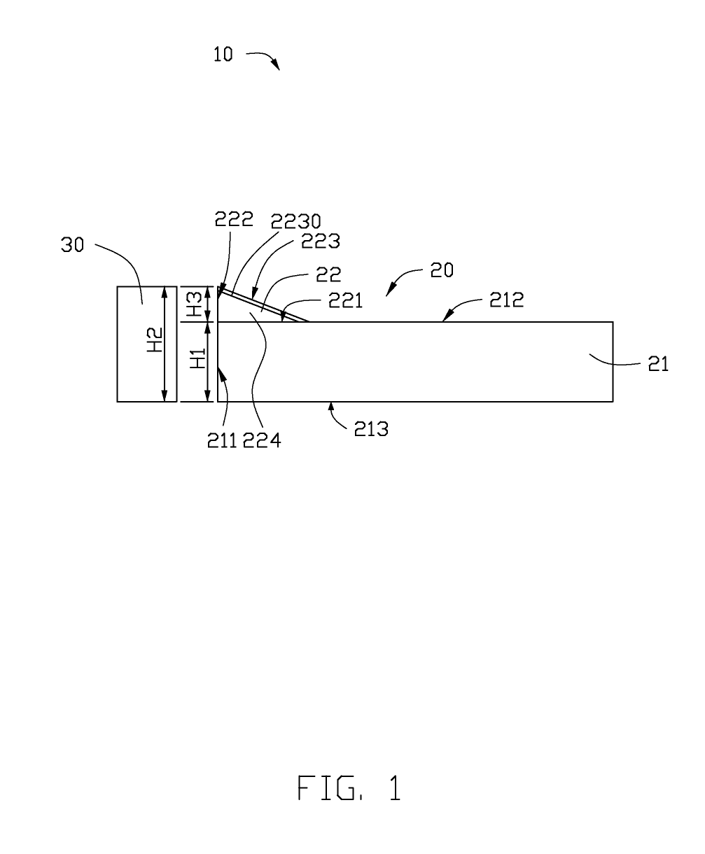

FIG. 1 illustrates a first embodiment of a backlight module 10 including a light guide plate 20 and at least one light source 30. The light guide plate 20 includes a light guide body 21 and a light collecting member 22 positioned on the light guide body 21.

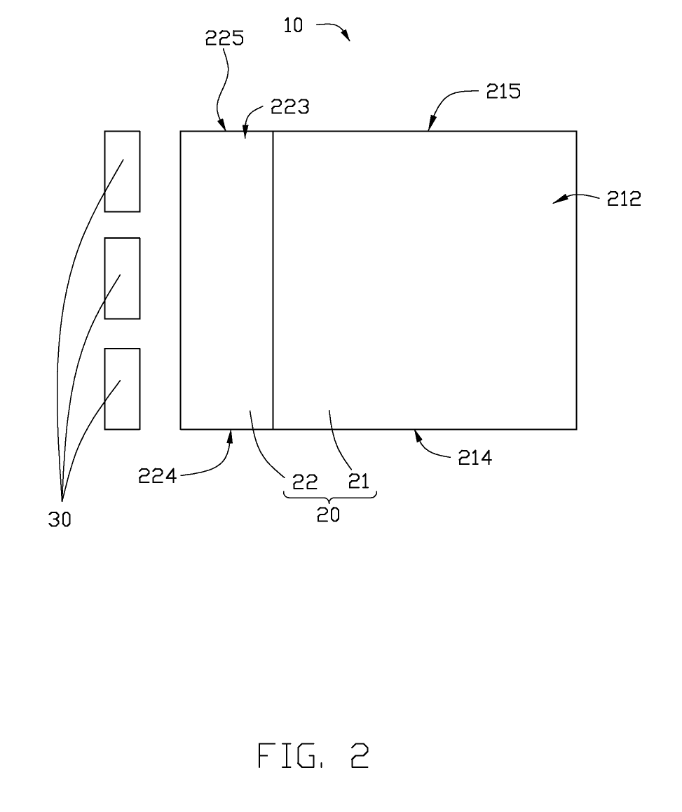

The light guide body 21 is substantially rectangular and includes a first light emitting surface 212, a first bottom surface 213 opposite to the first light emitting surface 212, a first light incident surface 211, and two first side surfaces 214, 215 (shown in FIG. 2). Each of the first light incident surface 211 and the two first side surfaces 214 and 215 is connected to and located between the first light emitting surface 212 and the first bottom surface 213. The two first side surfaces 214, 215 are connected to two opposite sides of the first light incident surface 211, respectively. The light guide body 21 is made of transparent glass which can be thinner than resin. In this embodiment, the first light incident surface 211 has a thickness represented as H1, wherein, the thickness H1 is less than 0.4 mm. Furthermore, the glass has a refractive index represented as “ng”.

The light collecting member 22 is positioned on the first light emitting surface 212 and adjacent to the first light incident surface 211. In at least one embodiment, the light collecting member 22 is substantially wedged shaped, and includes the following components connected to one another in the recited order: a second bottom surface 221, a second light incident surface 222, and an inclined surface 223. The second bottom surface 221 is attached to and covers a portion of the first light emitting surface 212 adjacent to the first light incident surface 211. The second light incident surface 222 is substantially perpendicular to the second bottom surface 221. The inclined surface 223 is connected to and located between the second bottom surface 221 and the second light incident surface 222, and is inclined with the second bottom surface 221 and the second light incident surface 222. In this embodiment, the second light incident surface 222 is aligned with the first light incident surface 211.

FIG. 2 illustrates that the light collecting member 22 further includes two second side surfaces 224 and 225 aligned with the two first side surfaces 214 and 215, respectively. Each of the two second side surfaces 224 and 225 is surrounded by the second bottom surface 221, the second light incident surface 222, and the inclined surface 223 (FIG. 1 only illustrates the second side surfaces 224 being surrounded by the second bottom surface 221, the second light incident surface 222, and the inclined surface 223).

Each light source 30 faces the first light incident surface 211 and the second light incident surface 222. Light emitted from the light source 30 enters the light guide plate 20 via the first light incident surface 211 and the second light incident surface 222. The light is then emitted from the first light emitting surface 212.

Although the first light incident surface 211 has a thickness H1 less than 0.4 mm, the second light incident surface 222 of the light collecting member 22 also allows the light from the light source 30 to enter the light collecting member 22. That is, the light collecting member 22 positioned on the light guide body 21 increases a size of the light incident surface of the light guide plate 20, thereby improving a light incident efficiency of the light source 30.

The light collecting member 22 is made of resin which has a refractive index represented as “np”. In this embodiment, np=ng±0.2. Since the refractive index “ng” is close to the refractive index “np”, thereby preventing a significant interface formed between the light guide body 21 and the light collecting member 22. In at least one embodiment, the resin may be selected from a group consisting of acrylic, polycarbonate, and polyethylene.

In at least one embodiment, a light emitting surface of the light source 30 facing the first light incident surface 211 and the second light incident surface 222 has a height represented as H2. The second light incident surface 222 has a thickness represented as H3. Wherein, the height H2 is greater than the thickness H1 (H2>H1), and a sum of the thicknesses H1 and H3 is equal to or greater than the height H2 (H1+H3≧H2), to further improve the light incident efficiency of the light source 30. In at least one embodiment, the backlight module 10 has a number of light sources 30 arranged in an array.

In at least one embodiment, the inclined surface 223 includes a reflecting layer 2230. As such, the light entering the light guide plate 20 via the first light incident surface 211 and the second light incident surface 222 is reflected by the reflecting layer 2230 back to the light guide body 21. The light is then emitted from the first light emitting surface 212. A luminous efficiency of the backlight module 10 is thus improved.

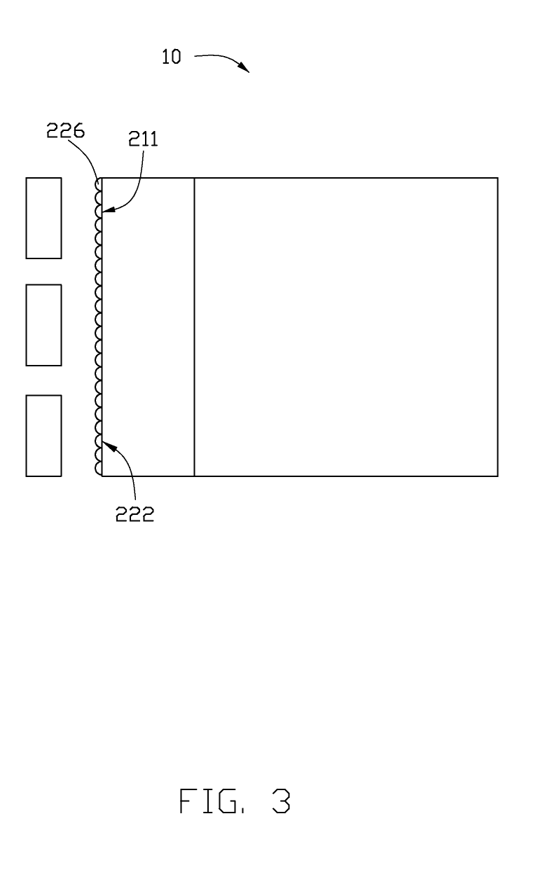

FIG. 3 illustrates a second embodiment, different from the first embodiment, of a backlight module 10. The light incident surface 211 of the backlight module 10 comprises a number of light diffusing microstructures 226 to diffuse the light entering the light guide plate 20. The light diffusing microstructures 226 may be made of glass or resin. In other embodiments, the light diffusing microstructures 226 may also be formed at the second light incident surface 222.

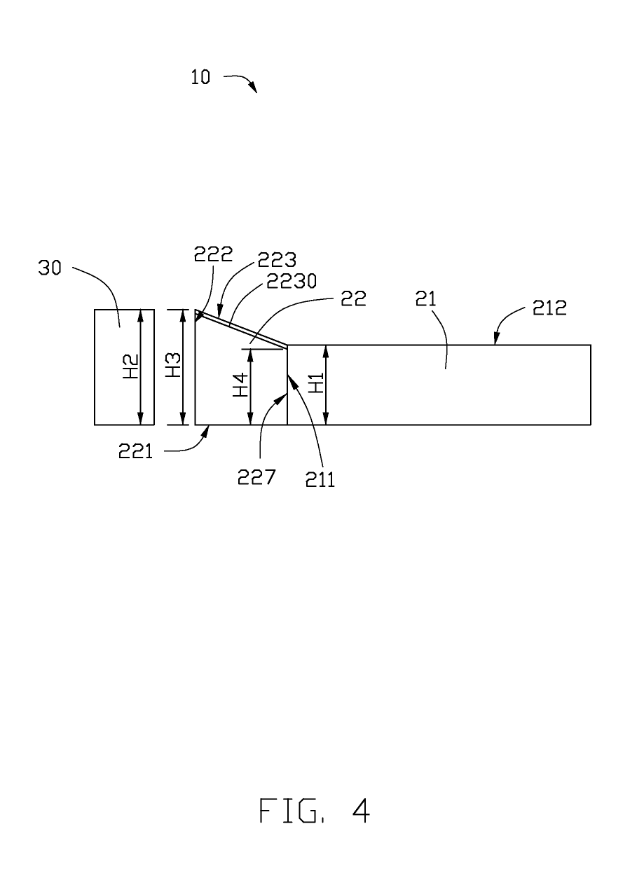

FIG. 4 illustrates a third embodiment, different from the first embodiment, of a backlight module 10. The light collecting member 22 is formed on the first incident surface 211 of the light guide body 21 and is located between the light source 30 and the light guide body 21. In at least one embodiment, the light collecting member 22 is substantially quadrangular prismatic in shape and further includes a second light emitting surface 227 connected to and located between the second bottom surface 221 and the inclined surface 223. That is, the following components are connected to one another in the recited order: the second bottom surface 221, the second light incident surface 222, the inclined surface 223, and the second emitting surface 227.

The size of the second light emitting surface 227 is less than the second light incident surface 222. Furthermore, the size of the second light emitting surface 227 matches the first incident surface 211, and is attached to the first incident surface 211. The inclined surface 223 includes a reflecting layer 2230. As such, the light entering the light collecting member 22 via the second light incident surface 222 is reflected by the reflecting layer 2230 back to the light collecting member 22, is emitted from the second light emitting surface 227 to the light guide body 21, and is then emitted from the first light emitting surface 212. The second light emitting surface 227 has a thickness represented as H4. Wherein, the height H2 is greater than the thickness H1, and the thickness H1 is equal to the thickness H4 (H2>H1=H4), and the thickness H3 is equal to or greater than the height H2 (H3≧H2).

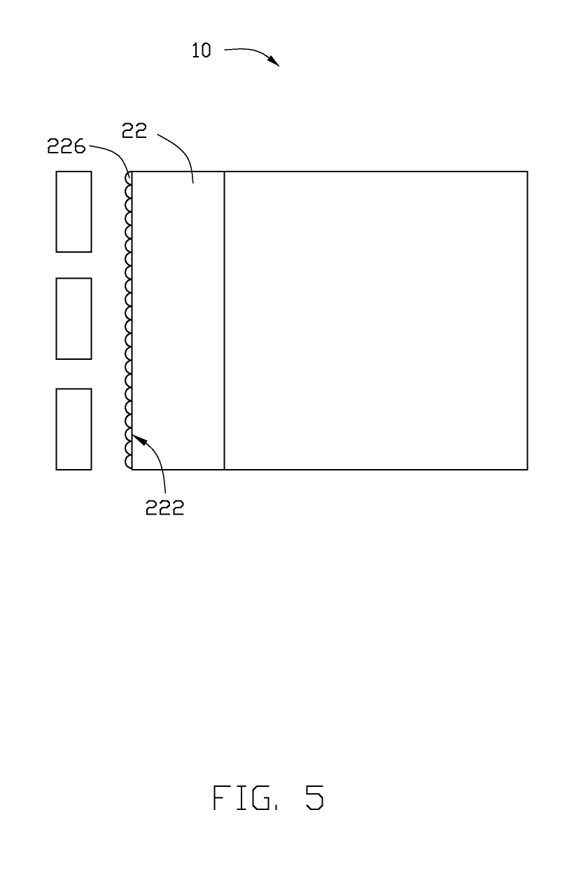

FIG. 5 illustrates a fourth embodiment of a back light module 10. Different from the third embodiment, the light collecting member 22 includes a number of light diffusing microstructures 226 formed at the second light incident surface 222, to diffuse the light entering the light collecting member 22. The light diffusing microstructures 226 may be made of glass or plastic.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A light guide plate comprising:
a light guide body comprising a first light incident surface and a first light emitting surface connected to the first light incident surface, the light guide body made of transparent glass; and
a light collecting member attached to and covering a portion of the first light emitting surface, the light collecting member being adjacent to the first light incident surface and made of resin.

2. The light guide plate of claim 1, wherein the glass has a refractive index represented as “ng”; the resin has a refractive index represented as “np”; wherein, np=ng±0.2.

3. The light guide plate of claim 1, wherein the light guide body further comprises a first bottom surface opposite to the first light emitting surface, and two first side surfaces; each of the first light incident surface and the two first side surfaces is connected to and located between the first light emitting surface and the first bottom surface; the two first side surfaces are connected to two opposite sides of the first light incident surface, respectively.

4. The light guide plate of claim 3, wherein the light collecting member is substantially wedged shaped, and further comprises a second bottom surface, a second light incident surface, and an inclined surface connected to one another in a recited order; the second bottom surface is attached to the portion of the first light emitting surface adjacent to the first light incident surface; the inclined surface is connected to and located between the second bottom surface and the second light incident surface, and is inclined with the second bottom surface and the second light incident surface.

5. The light guide plate of claim 4, wherein the second light incident surface is aligned with the first light incident surface.

6. The light guide plate of claim 5, wherein the light collecting member further comprises two second side surfaces each surrounded by the second bottom surface, the second light incident surface, and the inclined surface; the two second side surfaces are aligned with the two first side surfaces, respectively.

7. The light guide plate of claim 4, wherein the inclined surface comprises a reflecting layer to reflect light entering the light guide plate back to the light guide body.

8. The light guide plate of claim 4, wherein each of the light incident surface and the second light incident surface comprises a plurality of light diffusing microstructures to diffuse light entering the light guide plate.

9. The light guide plate of claim 1, wherein the light incident surface comprises a plurality of light diffusing microstructures to diffuse light entering the light guide plate.

10. The light guide plate of claim 9, wherein the light diffusing microstructures is made of glass or resin.

11. A backlight module comprising:
a light guide plate comprising:
a light guide body comprising a first light incident surface and a first light emitting surface connected to the first light incident surface, the light guide body made of transparent glass; and
a light collecting member attached to and covering a portion of the first light emitting surface, the light collecting member being adjacent to the first light incident surface and made of resin; and
at least one light source facing the first light incident surface and the second light incident surface.

12. The backlight module of claim 11, wherein, the first light incident surface has a thickness represented as H1, a light emitting surface of each light source facing the first light incident surface has a height represented as H2, the light collecting member comprises a second light incident surface having a thickness represented as H3; the height H2 is greater than the thickness H1, and a sum of the thicknesses H1 and H3 is equal to or greater than the height H2.

13. The backlight module of claim 12, wherein the thickness H1 is less than 0.4 mm.

14. A light guide plate applied in a backlight module including at least one light source, the light guide plate comprising:
a light guide body comprising a first light incident surface and a first light emitting surface connected to the first light incident surface, the light guide body made of transparent glass; and
a light collecting member including a second light incident surface and an opposite second light emitting surface, a size of the second light emitting surface being less than a size of the second light incident surface, matching the first incident surface, the second light emitting surface attached to the first incident surface, the light collecting member made of resin.

15. The light guide plate of claim 14, wherein the glass has a refractive index represented as “ng”; the resin has a refractive index represented as “np”; np=ng±0.2.

16. The light guide plate of claim 14, wherein the light guide body further comprises a first bottom surface opposite to the first light emitting surface, and two first side surfaces; each of the first light incident surface and the two first side surfaces is connected to and located between the first light emitting surface and the first bottom surface; the two first side surfaces are connected to two opposite sides of the first light incident surface, respectively.

17. The light guide plate of claim 16, wherein the light collecting member is substantially quadrangular prismatic in shape, and further comprises a second bottom surface and an inclined surface; the second bottom surface, the second light incident surface, the inclined surface, and the second light emitting surface are connected to one another in a recited order; the inclined surface is inclined with the second light incident surface and the second light emitting surface.

18. The light guide plate of claim 17, wherein the inclined surface comprises a reflecting layer to reflect light entering the light collecting member via the second light incident surface back to the light collecting member.

19. The light guide plate of claim 17, wherein the light collecting member comprises a plurality of light diffusing microstructures formed at the second light incident surface to diffuse the light entering the light collecting member.

20. The light guide plate of claim 19, wherein the light diffusing microstructures is made of glass or resin.
